(19) United States
(12) Patent Application Publication
(10) Pub. No.: US 2016/0174577 A1
(43) Pub. Date: Jun. 23, 2016

(54) Device to Prepare Turnovers

(71) Applicant: Alejandra I. Saldana Garza, Austin, TX (US)

(72) Inventor: Alejandra I. Saldana Garza, Austin, TX (US)

(21) Appl. No.: 14/578,018

(22) Filed: Dec. 19, 2014

(51) Int. Cl. A21C 9/06; A21C 11/00

(52) U.S. Cl. CPC A21C 9/063; A21C 11/006

(57) ABSTRACT

Device for food processing that facilitate the user the food processing preferably turnovers in a fast way and as a result, saves time and energy in this kind of work, which is comprised of a base element with two parts that can be folded in an independent way. In addition, it is provided with a top contact element and a closing element type lever. Besides, all the products produced with this device will came out in identical shape and size.

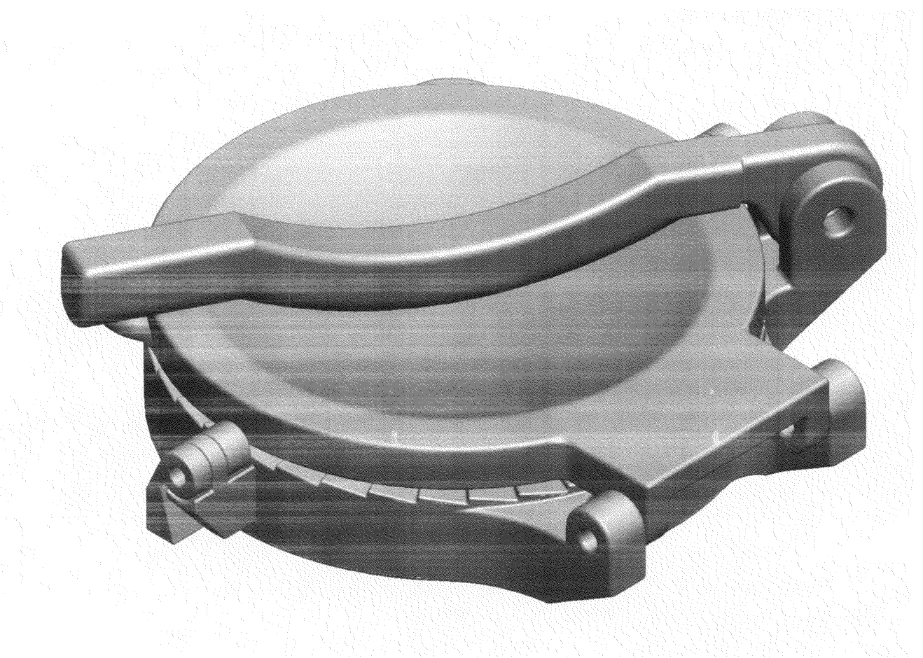

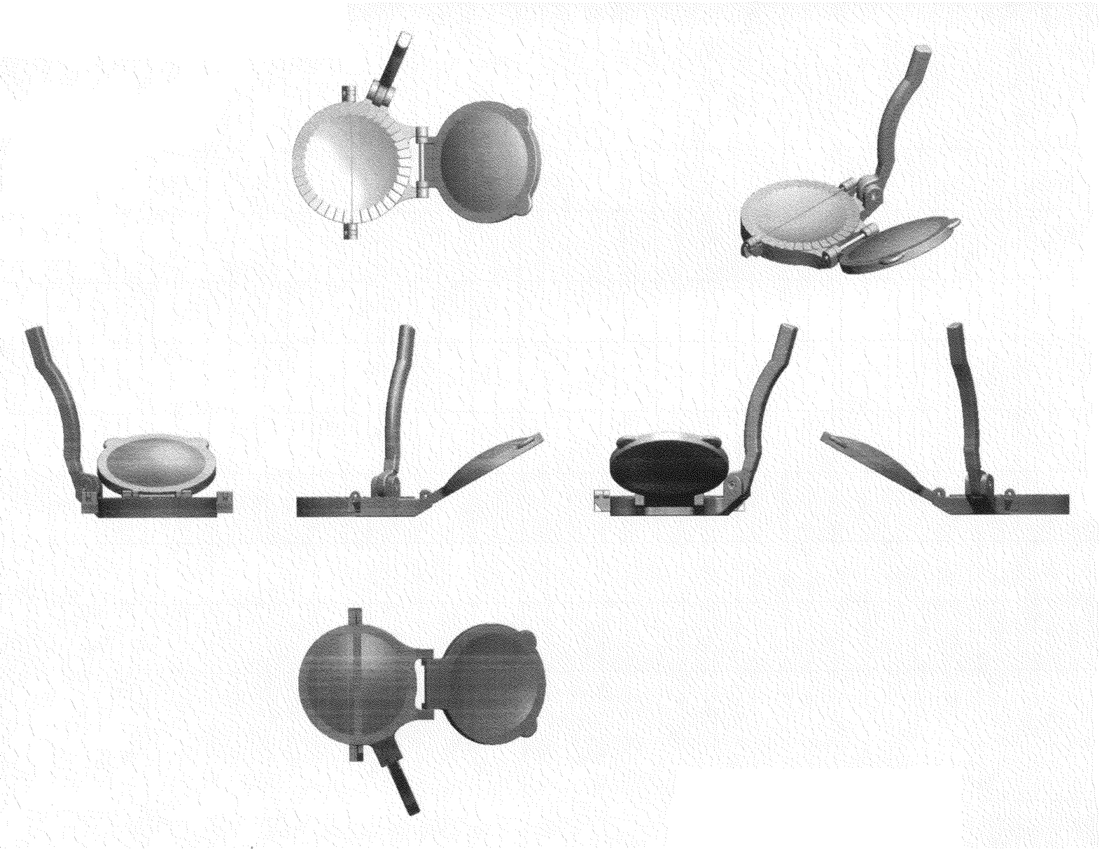

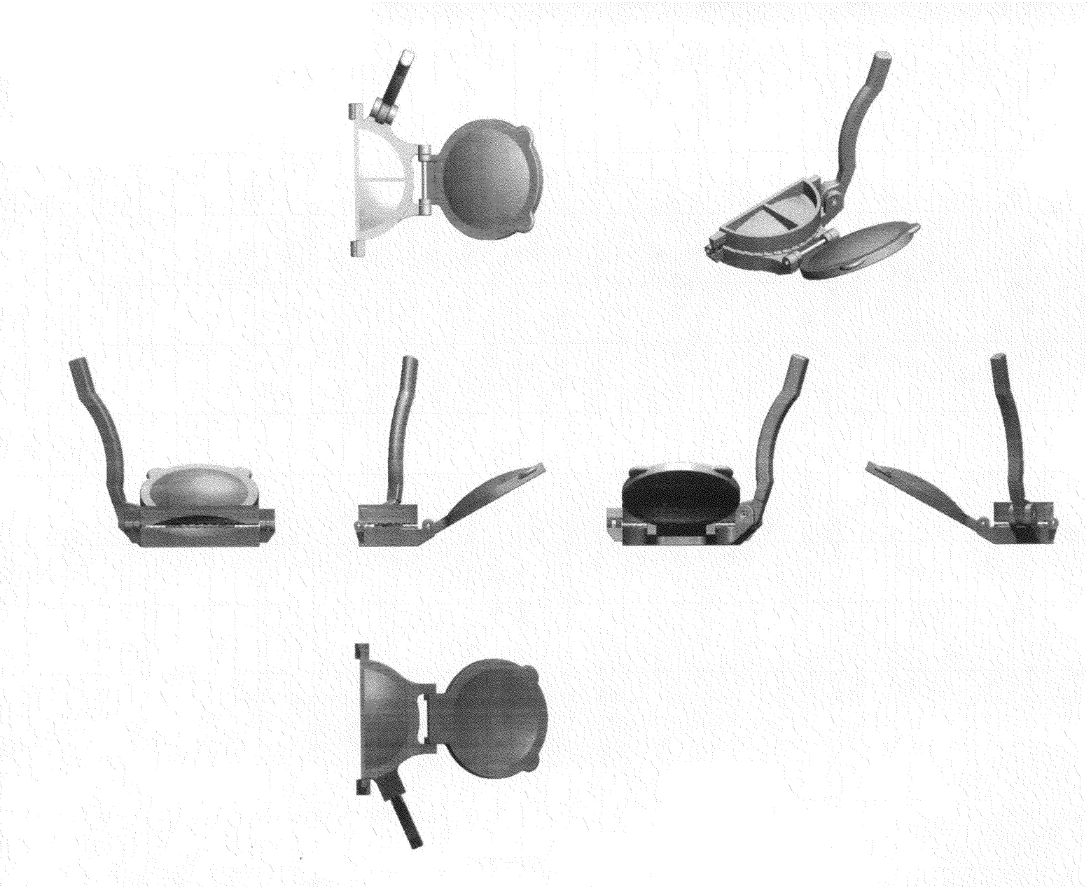

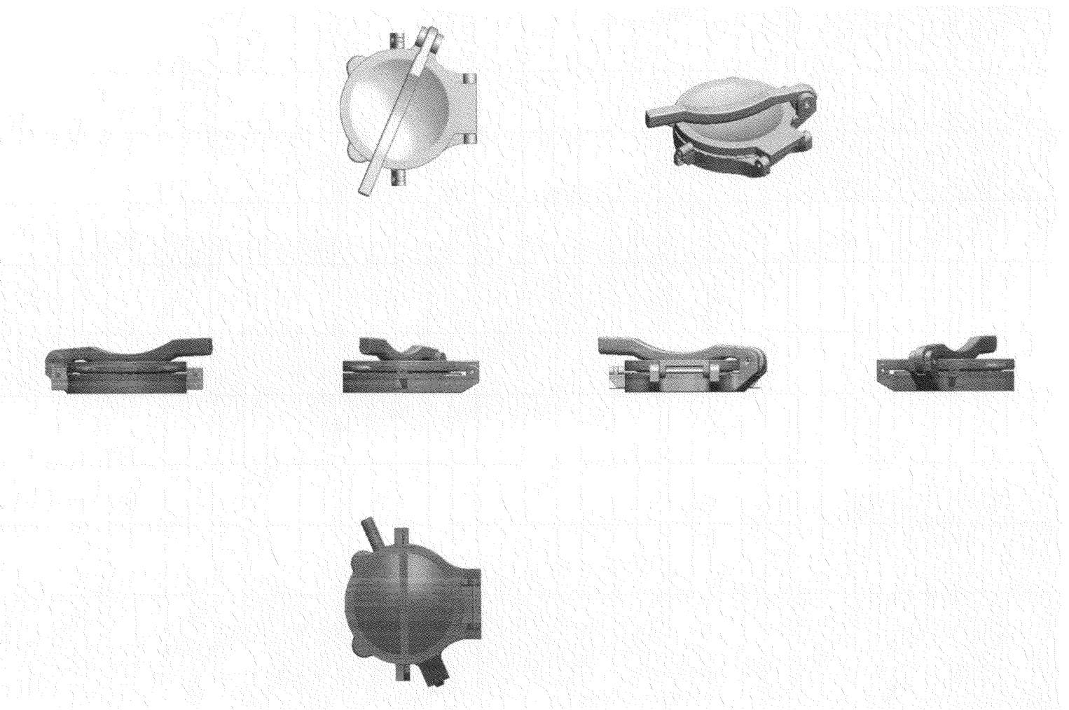

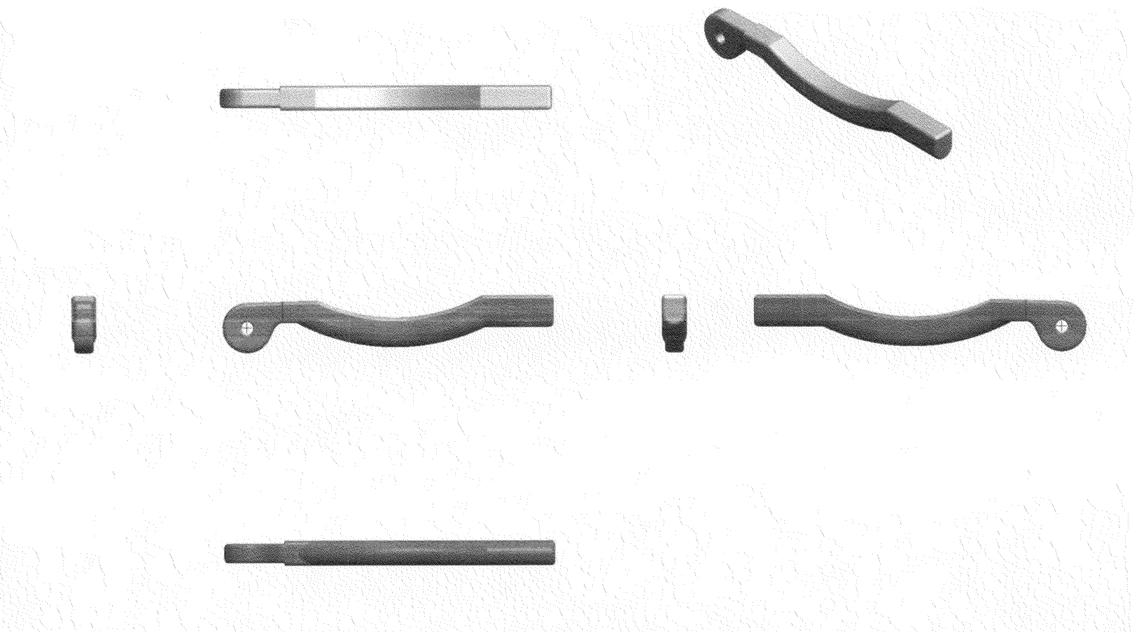

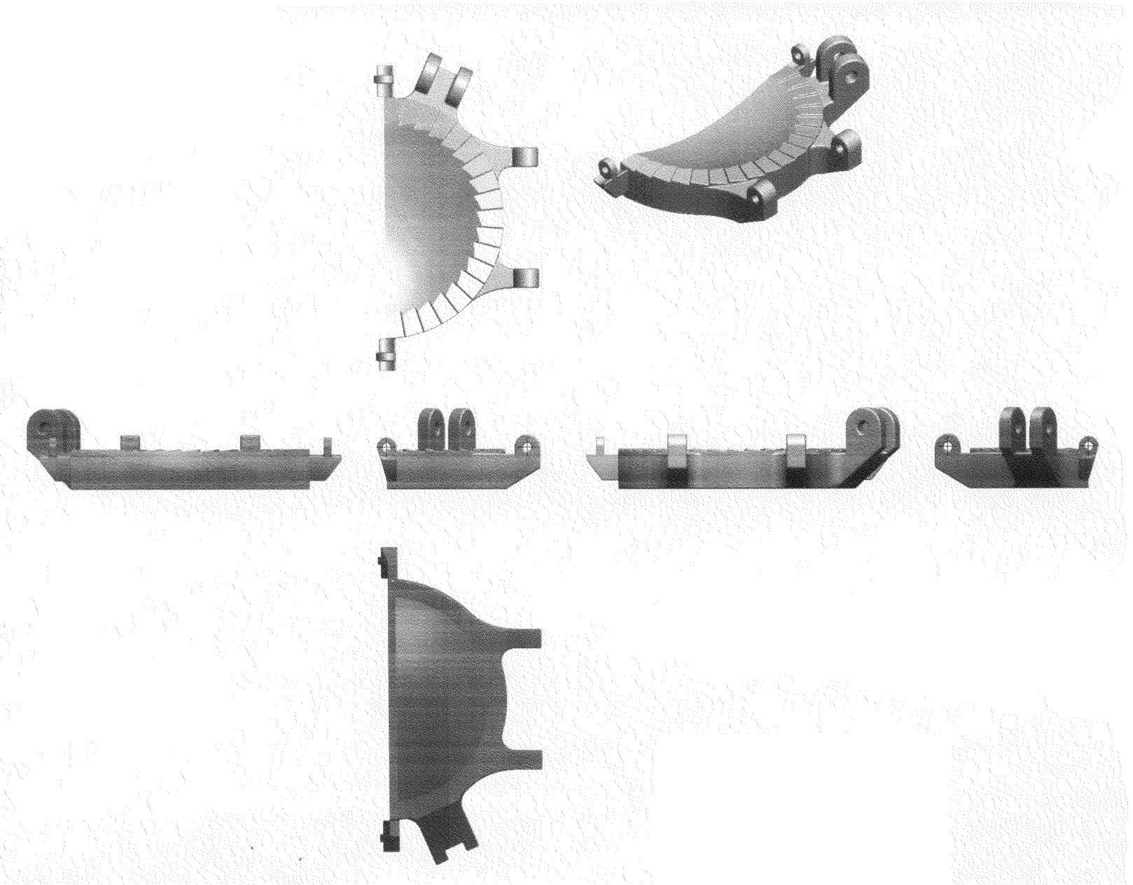

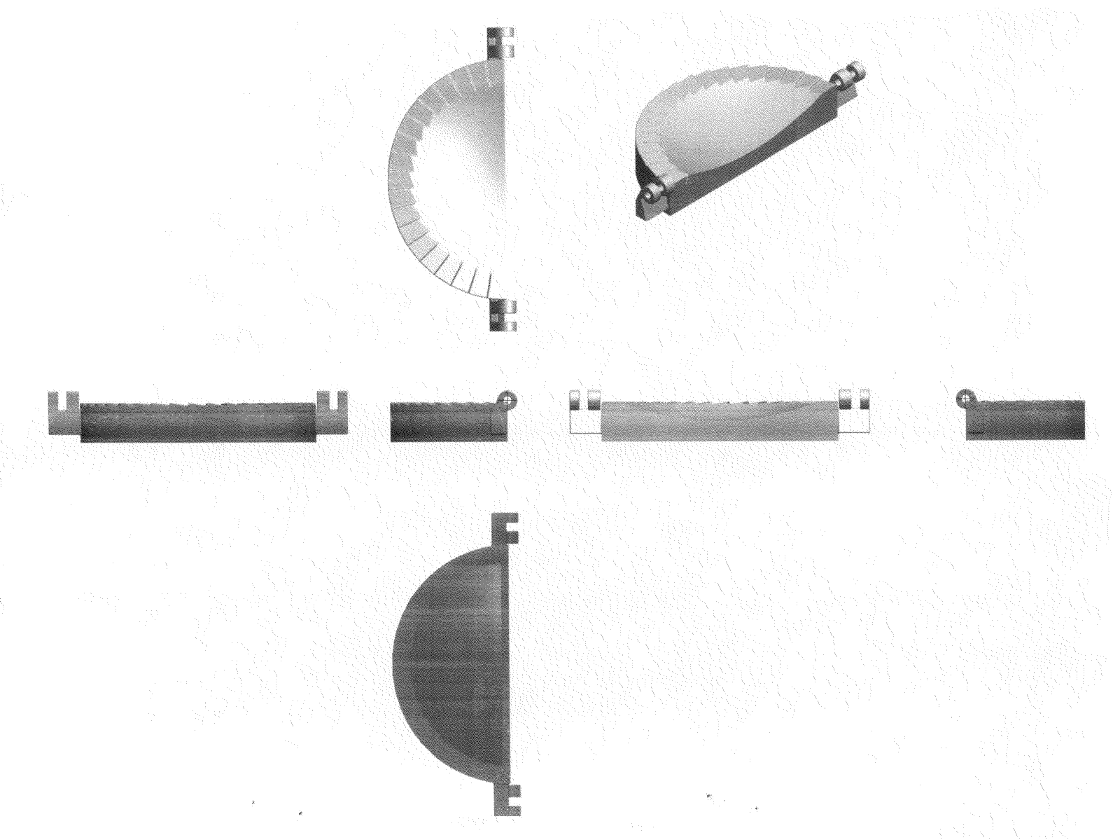

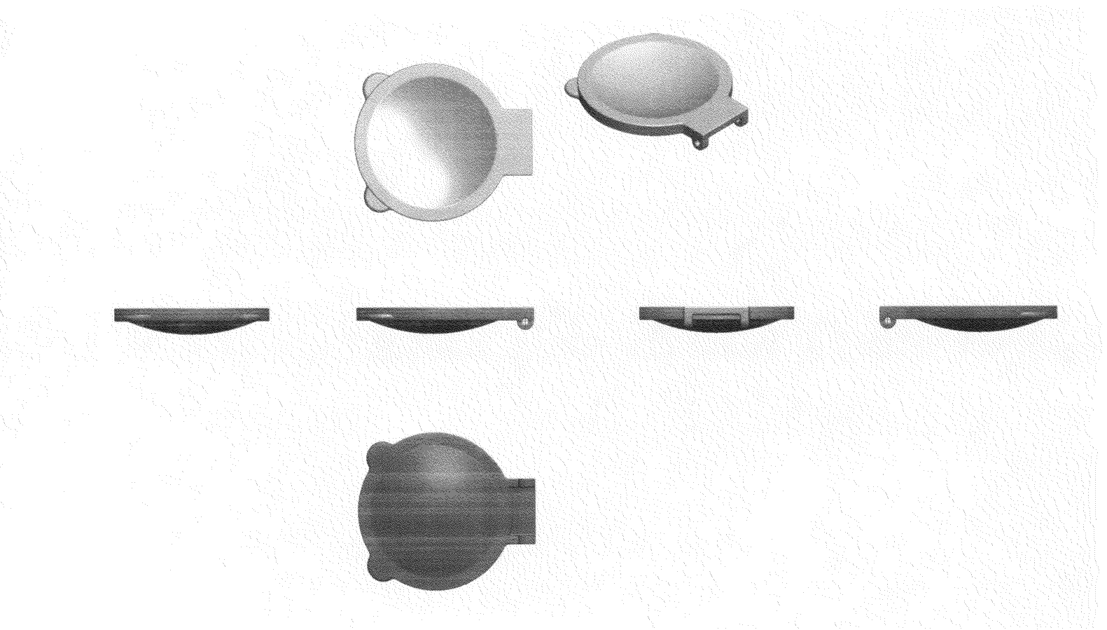

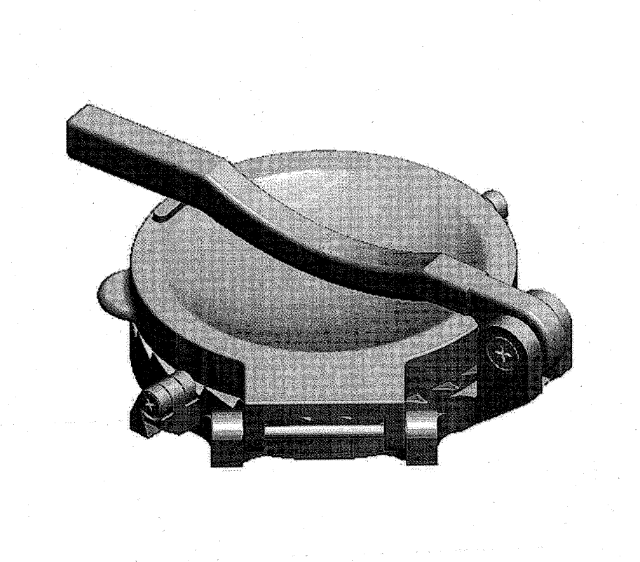

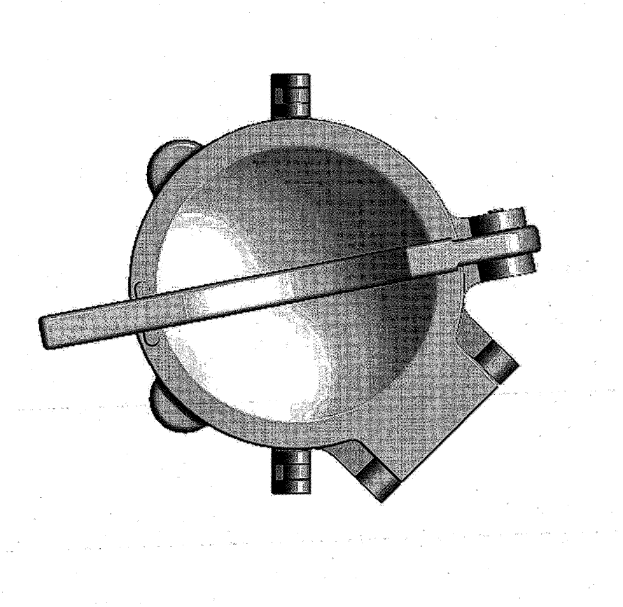

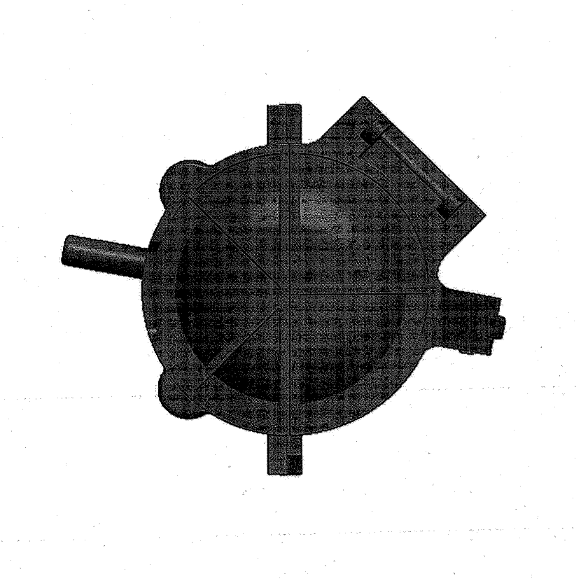

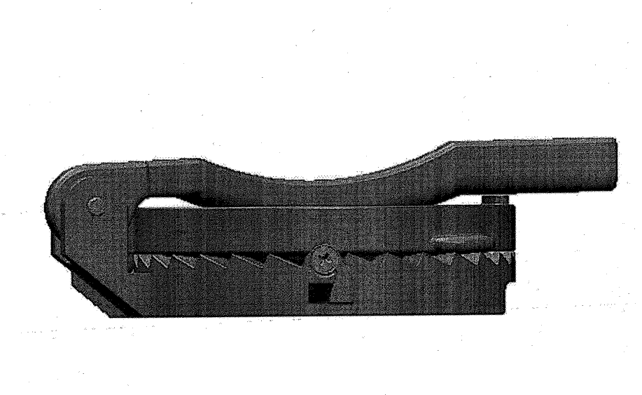

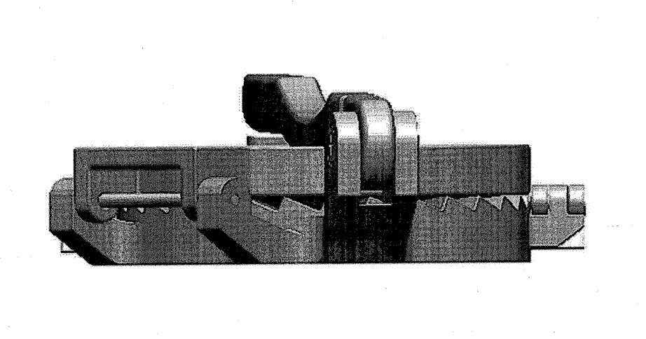

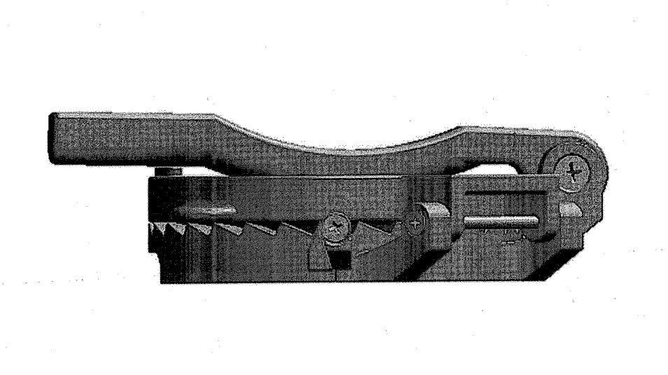

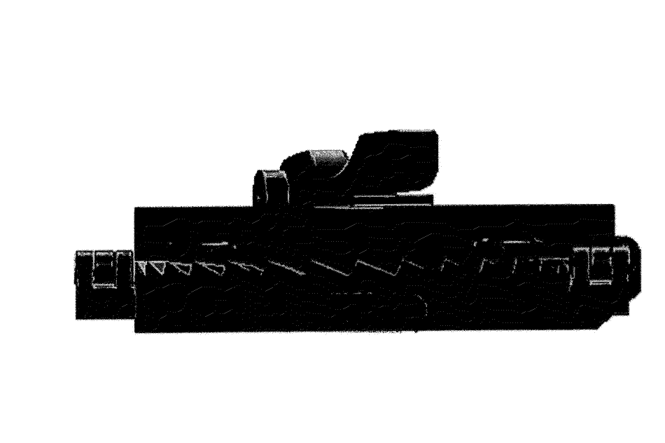

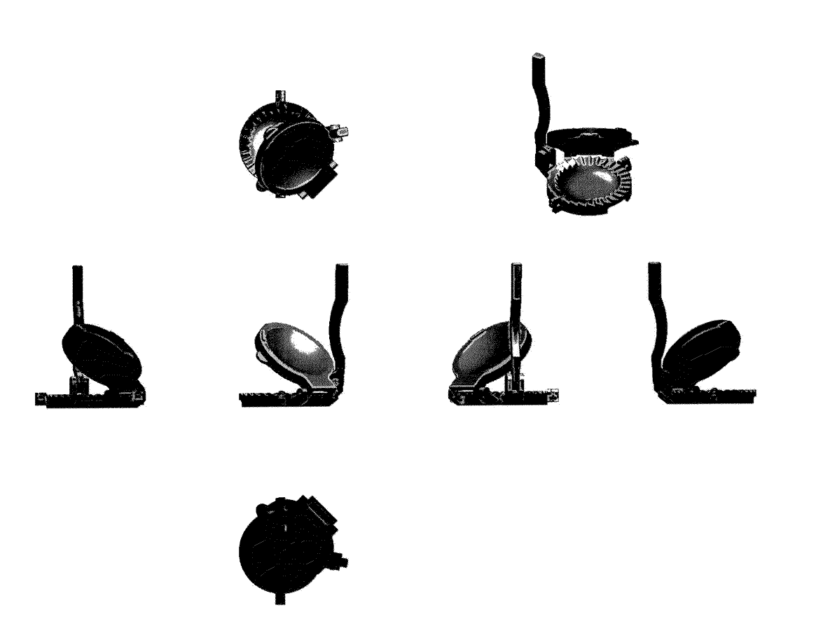

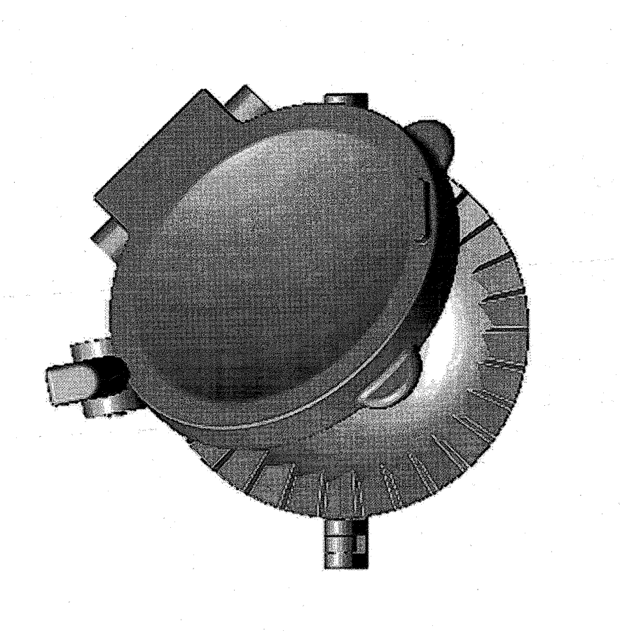

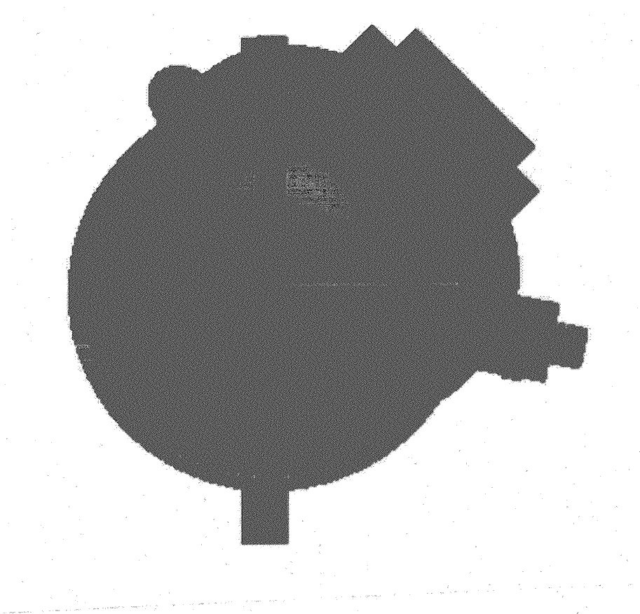

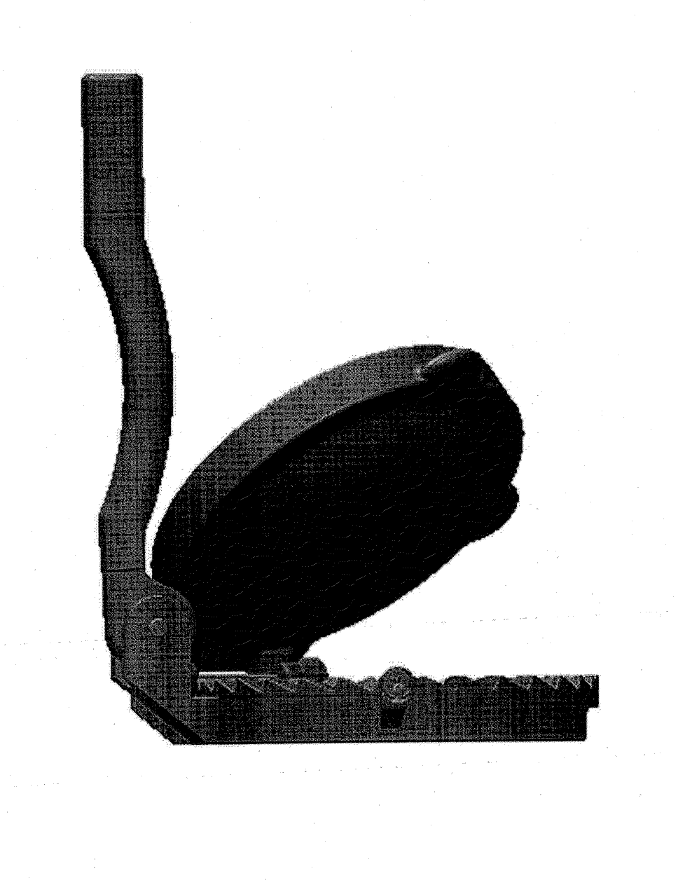

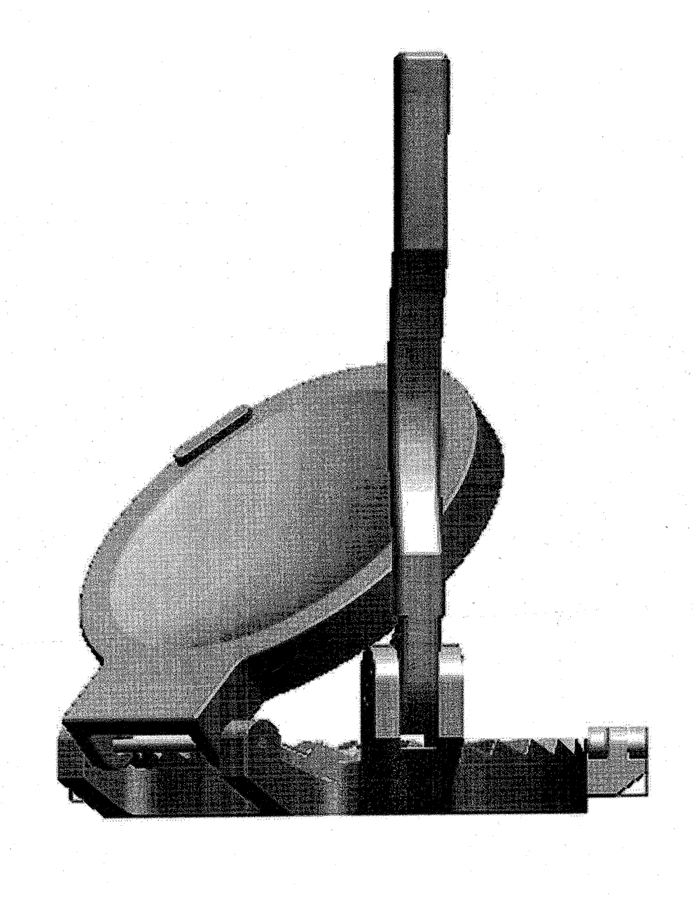

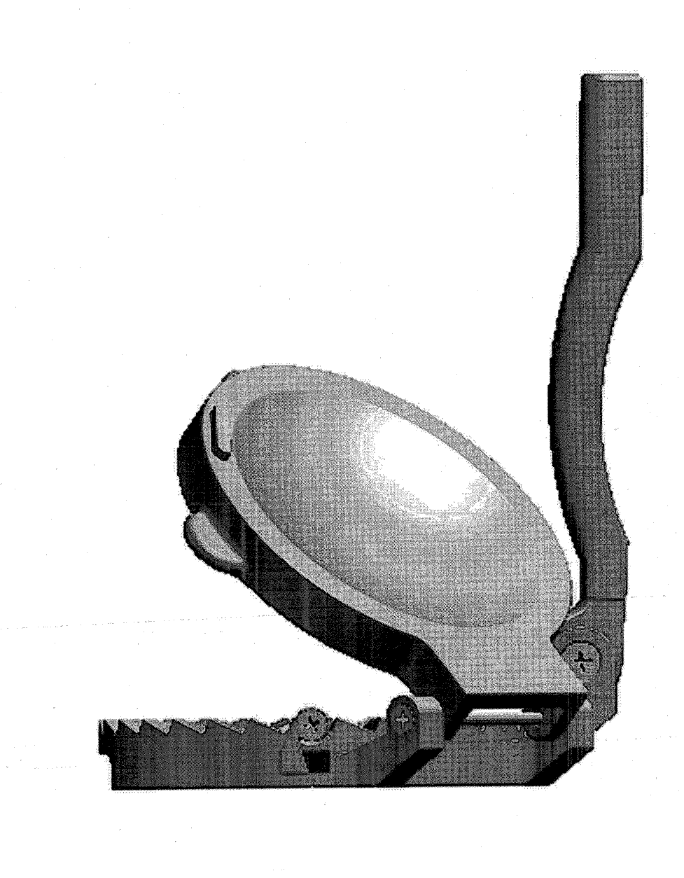

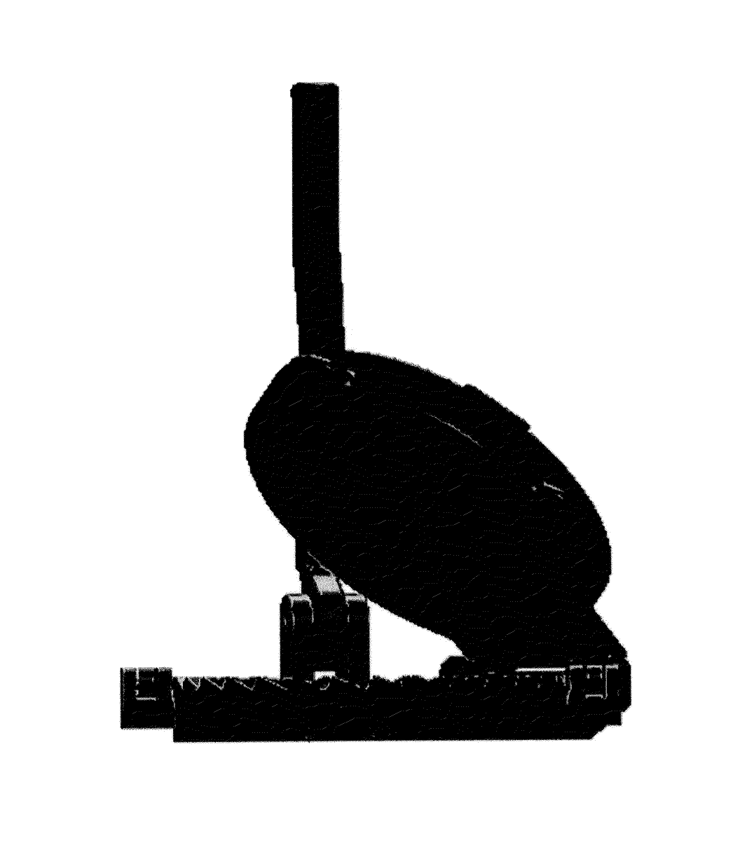

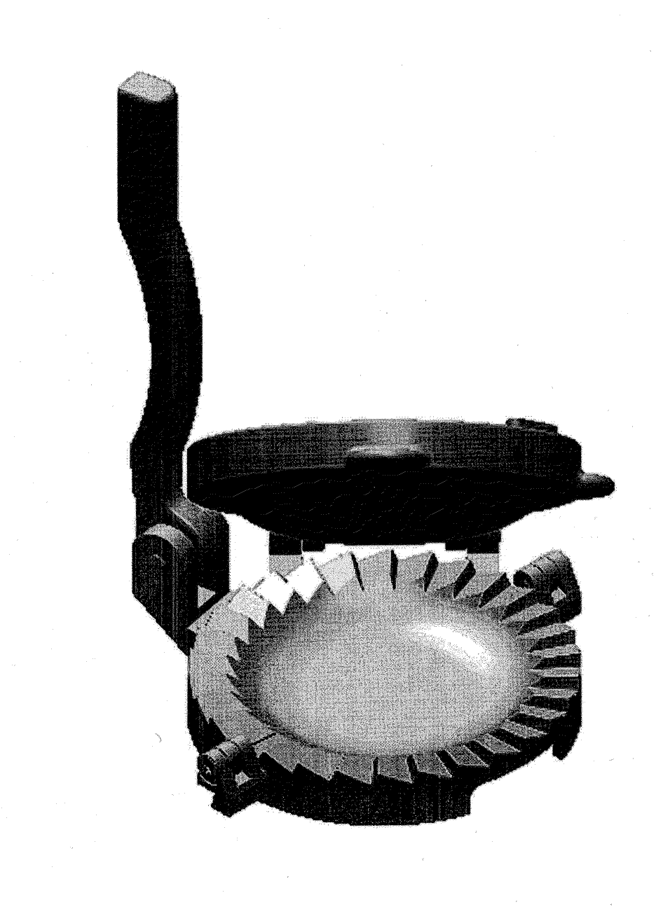

### BACKGROUND

There are some similar products on the market; however, this invention is a novelty product, since it has concave surfaces which allow the appropriate accommodation of the food to be prepared. In addition, it has a lever that makes sure that a similar quantity of the product is evenly distributed in each production cycle.

### BRIEF DESCRIPTION OF THE ILLUSTRATION

Picture 1 shows a perspective view of the device to prepare food in closed position.

Picture 2 shows a perspective view of the device to prepare food in open position.

### DEVICE TO PREPARE FOOD

The present invention refers to a device to prepare food, totally different to those already known, characterized by its special shape and ornament that give it its own and peculiar aspect.

The model is described in accordance with the illustration listed below:

Picture 1 is a perspective view of the device industrial model to prepare food.

Picture 2 is a perspective view of the device industrial model to prepare food in open position.

Picture 3 is a bottom view of the device industrial model to prepare food.

Picture 4 is a top view of the device industrial model to prepare food.

Picture 5 is a right side view of the device industrial model to prepare food.

Picture 6 is a left side view of the device industrial model to prepare food.

### DETAILED DESCRIPTION OF THE INVENTION

Device to prepare food that is composed of a base element preferably of circular figure with a concave shape in its upper surface and with a pattern with gradual undulations in its periphery, with a flat base on its lower surface and is divided in two parts, the part A (1) and the part B (2), which are joined by at least one element type hinge (5), that allows both parts to have a movement of opening and closing, in addition is provided with a top element (3) preferably of circular shape with a concave shape in its lower and upper surface of one piece, which is attached to part B (2) by a means of fastening hinge type (5), which allows that this top element have a movement of opening and closing with regard to the base element, additionally, it has a lever-type element (4), joined by fastening hinges type (5), to the part B, this element when manipulated will ensure the perfect closure of the base and top elements.

For its operation it is a simple device of curved shape since in the contact surfaces both elements resemble two dishes overlapping, the base is divided into two halves, that eventually will doubled by the half to give shape to the food preferably turnovers. Besides, all the periphery of the upper surface of the base element, has a design specially made to form the repulgo of the turnovers, the top has a smooth surface and is designed to press the dough and form the dough into a shape of concave tortilla that afterwards will be filled of various foods such as jam, meet and cheese among others and will fold to form the turnover.

This invention is preferable made of plastic, wood and cast iron or it can be made of any suitable material.

The person who uses this device to make turnovers no longer will have to use 2 or 3 different devices, so this device for food processing solves the problem of lengthy time consumption for making turnovers.

This utensil can be used for domestic use and restaurant sector. The benefit that it provides to the user is that it saves time and effort in making the turnovers.

Having described enough my invention, I consider as a novelty, and therefore I claim as my exclusive property contained in the following clauses:

1. Device for food processing characterized because it consist of a base element preferably of a circular shape concave in its upper surface and with a pattern of gradual undulations in its periphery, with a flat base on its bottom surface and that is divided in 2 parts, the part A and the part B which are joined at least with one element type hinge, which allows both parts to have a movement of opening and closing, in addition, is provided with a top element preferably of circular shape concave in its lower and upper surface of one piece, which is attached to part B by a means of fastening hinge which allows that this top element have a movement of opening and closing with regard to the base element, additionally it has a lever-type element, joined by an element of fastening hinge type to the part B, this element when manipulated ensures the perfect closure of the base and top elements.
